(19) United States
(12) Patent Application Publication
(10) Pub. No.: US 2021/0206329 A1
(43) Pub. Date: Jul. 8, 2021

(54) FULL DISPLAY MIRROR SYSTEM WITH RUGGEDIZED PORTABLE IMAGER

(71) Applicant: GENTEX CORPORATION, Zeeland, MI (US)

(72) Inventors: Bradley R. Hamlin, Allendale, MI (US); Michael G. Hendricks, Hamilton, MI (US); Drew D. Brennan, Holland, MI (US); David M. Falb, Grand Rapids, MI (US); Leah R. Hoffmeyer, Holland, MI (US); Thomas E. Humbert, Zeeland, MI (US)

(73) Assignee: GENTEX CORPORATION, Zeeland, MI (US)

(21) Appl. No.: 17/142,356

(22) Filed: Jan. 6, 2021

Related U.S. Application Data
(60) Provisional application No. 62/957,382, filed on Jan. 6, 2020.

(51) Int. Cl. B60R 11/04; B60R 1/08; H04N 5/225; H04N 7/18

(52) U.S. Cl. CPC B60R 11/04; B60R 1/08; B60R 2001/1253; H04N 7/183; H04N 5/2252

(57) ABSTRACT

An imaging and display system for a vehicle may comprise a first portable wireless vehicle imager mounted on a trailer and oriented to capture images from a first field of view having a vertical angle greater than the horizontal angle; a second portable wireless vehicle imager mounted one of the vehicle and the trailer and oriented to capture images from a second field of view having a vertical angle greater than the horizontal angle; an image processor for receiving and processing image data from the images captured by the first and the second portable wireless imagers and configured to generate a first supplementary image from a first portion of the first field of view, a second supplementary image from a second portion of the first field of view, and a first additional image from a first portion of the second field of view.

### CROSS REFERENCE TO RELATED APPLICATIONS

This application claims the benefit of and priority to U.S. Provisional Patent Application No. 62/957,382, filed on Jan. 6, 2020, entitled “Full Display Mirror System with Ruggedized Portable Camera,” the entire disclosure of which is hereby incorporated herein by reference.

### FIELD OF THE DISCLOSURE

The present invention generally relates to an in-vehicle imaging system with an external, wireless imager, and more particularly, a ruggedized portable imager.

### SUMMARY

According to an aspect of the present disclosure, an imaging and display system for use in a vehicle may comprise: a first portable wireless vehicle imager mounted on a trailer such that the first portable wireless vehicle imager may be oriented to capture images from a first field of view having a horizontal angle and a vertical angle greater than the horizontal angle; an image processor for receiving and processing the image data from the images captured by the first portable wireless imager, the image processor configured to generate at least a first supplementary image from a first portion of the first field of view and a second supplementary image from a second portion of the first field of view; and a display mounted in the vehicle and in communication with the image processor for displaying at least one of the first supplementary image and the second supplementary image.

The first supplementary image may correspond to a portion of the first field of view and may be cropped from a lower portion of the first field of view, and the second supplementary image corresponds to a portion of the first field of view and may be cropped from a portion of the first field of view above the lower portion. The first portable wireless imager may comprise: a center housing band; a first cover received in the center housing band within a first open side thereof and having a lens assembled therewith; a second cover received in the center housing band within a second open side opposite the first open side; and a printed circuit board having an image sensor mounted thereon, the printed circuit board being positioned within the center housing with the image processor aligned with the lens. The imaging and display system further may comprise a second portable wireless imager configured to have a second field of view different from the first field of view of the first portable wireless imager; the second portable wireless imager may be in communication with the image processor; and the image processor may be configured to generate at least a first additional image from a first portion of the second field of view and a second additional image from a second portion of the second field of view. The first portable imager may be disposed such that the lower portion of the first field of view includes a rear bumper of the trailer. The first portable imager may be configured to be selectively attachable to and removable from the trailer using a mount.

An image sensor may be disposed on a printed circuit board within a housing, the printed circuit board further may comprise a wireless communication module; and the wireless communication module may be capable of allowing the image sensor to wirelessly communicate with the image processor and to stream video of captured images. The imaging and display system further may comprise an antenna extending from the housing, the antenna configured to allow the wireless communication module to be in selective communication with the image processor; and the first portable imager may be provided with controls configured to allow the establishment of a wireless connection with the image processor. The imaging and display system further may comprise a memory in communication with the image processor and configured to selectively store images received or processed by image processor.

According to another aspect, a portable wireless vehicle imager may comprise a housing comprising: a center housing band; a first cover received in the center housing band within a first open side thereof and having a lens assembled therewith; and a second cover received in the center housing band within a second open side opposite the first open side; and a printed circuit board having an image sensor mounted thereon, the printed circuit board being positioned within the center housing with the image processor aligned with the lens; wherein the housing may be fully enclosed and sealable to be water-proof.

The portable wireless vehicle imager further may comprise a plurality of supports extending from the first cover within the center housing band and a plurality of projections extending from the second cover within the center housing band and toward respective ones of the plurality of supports; and the first cover and second cover may abut a first interior feature and a second interior feature of the center housing band to retain the first cover and second cover with the center housing band. The portable wireless vehicle imager further may include a wireless communication module in communication with the printed circuit board and configured for transmitting an image gathered by the image sensor to a remote processor. The portable wireless vehicle imager further may include an antenna secured to the housing and communicatively connected with the wireless communication module. The first cover may include a lens aperture for receiving a portion of a lens unit including a lens such that the lens may be exposed externally of the portable wireless vehicle imager. The portable wireless vehicle imager further may comprise at least one external control positioned on the housing for facilitating use of portable imager. The at least one external control may comprise at least one of a pair button, a power button, and a reset button.

According to another aspect, an imaging and display system for a vehicle may comprise a first portable wireless vehicle imager mounted on a trailer such that the first portable wireless vehicle imager may be oriented to capture images from a first field of view having a horizontal angle and a vertical angle greater than the horizontal angle; a second portable wireless vehicle imager mounted one of the vehicle and the trailer such that the second portable wireless vehicle imager may be oriented to capture images from a second field of view having a horizontal angle and a vertical angle greater than the horizontal angle; an image processor for receiving and processing image data from the images captured by the first and the second portable wireless imagers, the image processor configured to generate at least a first supplementary image from a first portion of the first field of view, a second supplementary image from a second portion of the first field of view, and a first additional image from a first portion of the second field of view; and a display mounted in the vehicle and in communication with the image processor for displaying at least one of the first supplementary image, the second supplementary image, and the first additional image.

The image processor may be further configured to generate a second additional image from a second portion of the second field of view; and the display may be configured to selectively display the second additional image. The first supplementary image may correspond to a portion of the first field of view and may be cropped from a lower portion of the first field of view, the second supplementary image may correspond to the first field of view and may be cropped from a portion of the first field of view above the lower portion, and the first additional image may correspond to a portion of the second field of view. A first image sensor may be disposed on a first printed circuit board within a first housing associated with the first portable wireless vehicle imager, the first printed circuit board further may comprise a first wireless communication module; and the first wireless communication module may be capable of allowing the first image sensor to wirelessly communicate with the image processor and to stream video; a second image sensor may be disposed on a second printed circuit board within a second housing associated with the second portable wireless vehicle imager, the second printed circuit board further may comprise a second wireless communication module; and the second wireless communication module may be capable of allowing the second image sensor to wirelessly communicate with the image processor and to stream video. The first portable imager may be provided with first controls configured to allow the establishment of a wireless connection with the image processor; and the second portable imager may be provided with second controls configured to allow the establishment of a wireless connection with the image processor. The imaging and display system further may comprise a memory in communication with the image processor and the memory may be configured to selectively store images received or processed by image processor. The imaging and display system further may comprise an antenna extending from housing, the antenna configured to allow the wireless communication module to be in selective communication with the image processor.

According to one aspect of the present disclosure, a portable wireless vehicle imager includes a center housing band, a first cover received in the center housing band within a first open side thereof and having a lens assembled therewith. A plurality of supports extending from the first cover within the center housing band. The portable imager further includes a second cover received in the center housing band within a second open side opposite the first open side. A plurality of projections extending from the second cover within the center housing band and toward respective ones of the plurality of supports. The portable imager further includes a printed circuit board having an image sensor mounted thereon. The printed circuit board may be positioned within the center housing and may be received between and in supporting contact with the plurality of supports and respective ones of the plurality of projections with the image processor aligned with the lens.

According to another aspect of the present disclosure, an imaging and display system for use in a vehicle pulling a trailer includes the above-described portable wireless vehicle imager mounted on the trailer such that the portable wireless vehicle imager may be oriented to receive images from a first field of view having a horizontal angle and a vertical angle where the vertical angle is greater than the horizontal angle. The system further includes an image processor for receiving images from the portable wireless imager and a display mounted in the vehicle and in communication with the image processor for displaying at least one of the rearward image, the back-up image, and both the rearward and back-up images.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a side view of a vehicle and trailer incorporating an imaging and display system;

FIG. 2 is a top view of the vehicle and trailer of FIG. 1;

FIG. 3 is a front-perspective view of an imager useable in the imaging and display system;

FIG. 4 is a rear-perspective view of the imager of FIG. 3;

FIG. 5 is an exploded front perspective view of the imager of FIG. 3;

FIG. 6 is an exploded rear perspective view of the imager of FIG. 3;

FIG. 7 is an electrical circuit diagram in block form of the imaging and display system used in FIGS. 1 and 2;

FIG. 8 is a schematic representation of a display and an image sensor used in the imaging and display system shown in FIGS. 1-3 showing the display when the vehicle is in reverse gear; and

FIG. 9 is a schematic representation of a display and an image sensor used in the imaging and display system shown in FIGS. 1-4 showing the display when the vehicle is not in reverse gear.

### DETAILED DESCRIPTION OF THE EMBODIMENTS

FIGS. 1-5 show an example of an image and display system 10 as well as a vehicle 25 and trailer 15 in which the image and display system 10 may be implemented. As used herein, the term “trailer” refers to items being towed by vehicle 25 such as trailers, recreational vehicles, boats, semi-trailers, and the like. In situations in which a vehicle tows more than one item, the term “trailer” may refer to all the items being towed. As shown, image and display system 10 may include a first portable camera or imager 12 comprising an image sensor 14 and mounted on the trailer 15 configured to capture first images. Image and display system 10 may further comprise an image processor 30 for receiving image data from the first images captured by first portable imager 12 and for processing the image data from the first images to create at least one supplementary image from the first images. The first images may comprise still images or video images. The at least one supplementary image from each first image captured by the first portable imager 12 may comprise, for example, a first supplementary image such as a back-up image 52 and a second supplementary image such as a rearward image 55. Back-up image may comprise an image of a scene immediately behind trailer 15 and rearward image 55 may comprise a scene behind the trailer 15 including a portion of the scene further behind the trailer 15 than the scene in the back-up image.

Image and display system 10 may further comprise a display 40 in communication with the image processor 30. Display 40 may be mounted in the vehicle 25. Display may be configured to display at least one of the first supplementary image, the second supplementary image, and the first image.

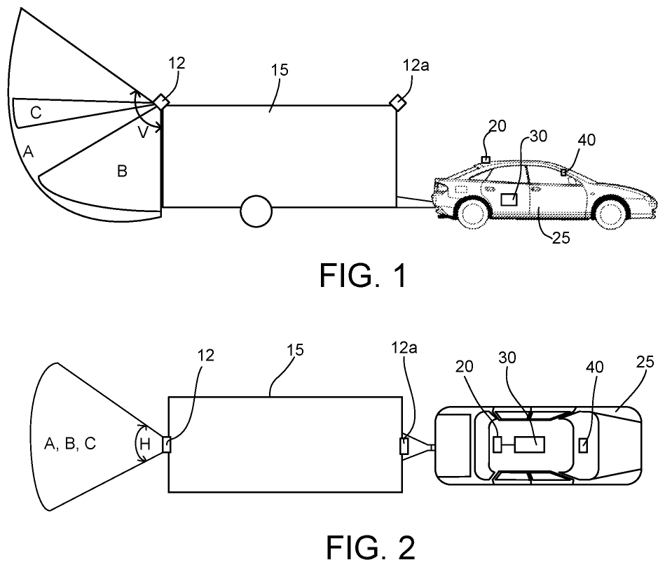

With reference to FIGS. 1 and 2, the first portable imager 12 may be mounted to the trailer 15 such that the first portable imager 12 may be oriented to receive images from a first field of view A having a horizontal angle H and a vertical angle V. In some embodiments, the vertical angle V may be greater than the horizontal angle H. In some embodiments, first portable imager 12 may be a conventional camera or imager that is rotated 90 degrees so as to obtain the first field of view A. The first portable imager 12 may also be aimed downward such that a lower part of the first field of view A includes a rear bumper of the trailer 15 and extends upward from the bumper of the trailer 15. First supplementary image may comprise, for example, back-up image showing the lower portion of the scene captured by first portable imager 12. Second supplementary image may comprise, for example, rearward image, and may include a portion of the scene above the scene in back-up image. In some embodiments, a portion of the scene captured by first portable imager 12 may appear in both first supplementary image and second supplementary image. In some embodiments, there is no overlap between the portion of the first image in the first supplementary image and the second supplementary image.

Upon processing by image processor 30, supplementary images from different portions of captured images may have different resolutions and/or may be displayed at different scales. For example, a vehicle that may appear in two separate supplementary images, such as in back-up image and rearward image, may appear to be larger in back-up image than in rearward image or vice-versa.

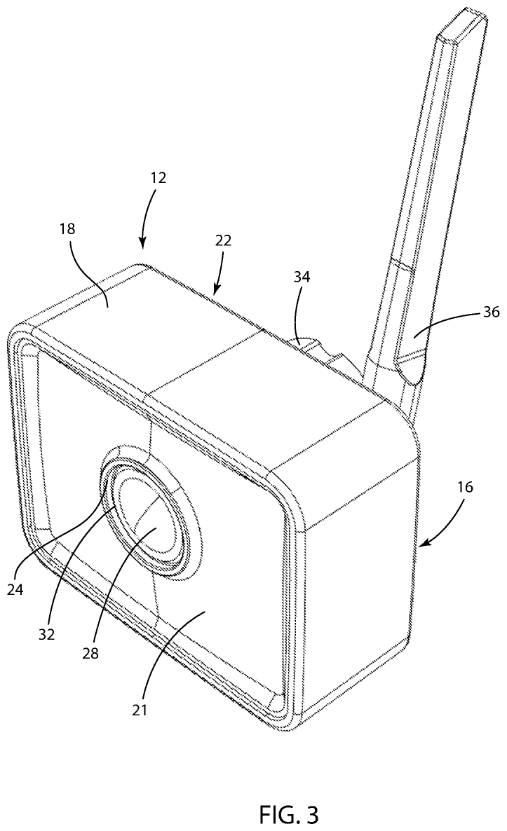

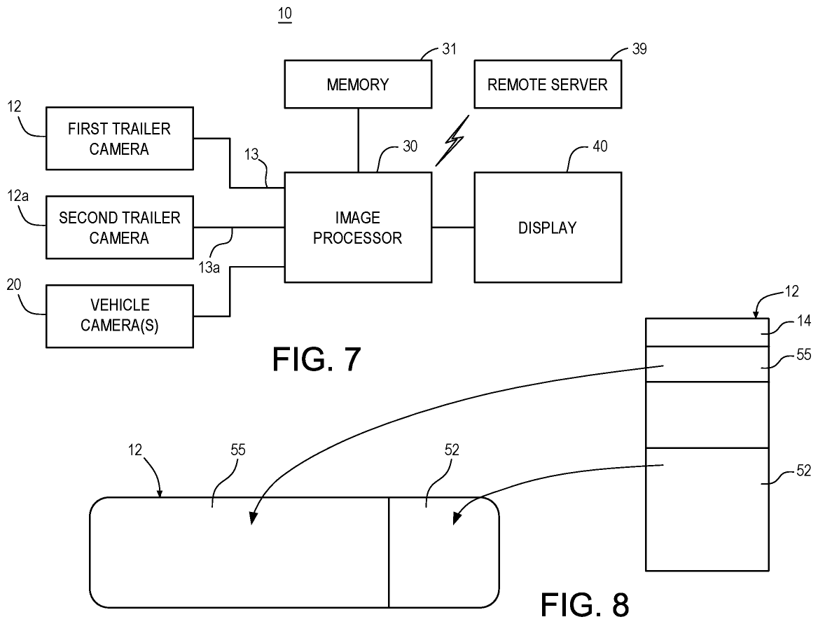

As shown in FIGS. 3-5, first portable imager 12 may be specifically configured for use in an external vehicle application. In particular, first portable imager 12 may include a housing 16 that is fully enclosed and sealable to provide a water-resistant or generally water-proof (e.g. at regular atmospheric temperature) housing 16. Further, housing 16 may be configured for mounting on vehicle 25 and/or trailer 15 and to facilitate portable or temporary use with image and display system 10, including by providing controls for establishing a wireless connection 13 (FIG. 7) with image processor 30. In this manner, one or more portable imagers 12, 12A may be mounted on vehicle 25 or trailer 15 to substitute for a permanent, vehicle-mounted portable imager 12 that may have its field of view obstructed by trailer 15. Portable imager 12 may be modular such that a number of different bases may be assembled with housing 16 at mount 34. In various examples such bases may include clips, suction mounts, flat or curved surfaces for adhesive attachment or the like.

As shown in FIG. 7, image and display system 10 may comprise at least one additional portable camera or imager 12A. The additional portable imagers 12A may be disposed to provide a user with additional views such as a view of the towing vehicle from behind, a view of the trailer 15 being towed from the front, a view of the interior of the trailer 15 being towed, and a view of the surroundings of at least one of the towing vehicle and the trailer 15 being towed.

Similar to first portable imager 12, as shown in FIG. 7, image and display system 10 may include at least a second portable camera or imager 12A. Second portable imager 12A may be configured similar to first portable imager 12 and may have similar capabilities. Second portable imager 12A may be capable of being mounted on the vehicle 25 or on or in trailer 15. Similar to first portable imager 12, second portable imager 12A may be mounted to the trailer 15 or the vehicle 25 such that second portable imager 12A may be oriented to receive second images from a second field of view of second portable imager 12A having a vertical angle greater than the horizontal angle of the second field of view. The second field of view of second portable imager 12A may have an aspect ratio of about 9:16. In some embodiments, second portable imager 12A may be a conventional camera or imager that is rotated 90 degrees so as to obtain the second field of view.

Similar to what is done with images captured by first portable imager 12, image processor 30 may likewise be capable of receiving second images from the second portable imager 12A and processing the second images to create at least one additional image from the second images. In some embodiments, image processor 30 may be configured to crop the second images received from the second portable imager 12A into a group of additional images. The group of additional images may include a first additional image that comprises a lower portion of the second field of view such as, for example, an image encompassing a trailer hitch. The group of additional images may further include a second additional image having a higher portion of the second field of view such as a field of view forward of and/or above the vehicle 25. For example, the higher portion of the second field of view may be of the bed of a truck that is pulling trailer 15. In some embodiments, for example, the at least one additional image from each second image captured by the second portable imager 12A may comprise first additional image of a scene immediately adjacent to the trailer 15 and second additional image comprising a scene on the same side of the trailer 15 as the first additional image but showing it from a field of view that captures objects further away from the trailer 15 than those in the first additional image. In another example, the at least one additional image from each second image captured by the first portable imager 12 may comprise a first additional image of a scene immediately behind the towing vehicle 25 and including the trailer hitch. The at least one additional image may further comprise a second additional image comprising a scene of the front of the trailer 15. In yet another example, the at least one additional image from each second image captured by the first portable imager 12 may comprise a first additional image of a scene inside the trailer 15. The first additional image may show the floor and/or a lower portion of the interior of the trailer 15. The at least one additional image may further comprise a second additional image comprising a scene of the interior of the trailer 15 but of a higher portion of the interior of the trailer 15 than that in the first additional image. In some embodiments, second portable imager 12A may capture a second image and process only a portion of the image for display, for example a single field of view of an interior of the trailer 15.

Portable imagers 12, 12A may be in communication with a memory 31. Portable imagers 12, 12A may be configured to transmit image data from captured images to memory 31. Memory 31 may be configured to store the transmitted image data for a period of time. In some embodiments, memory 31 may store image data, for example, for a certain time period, after which new image data may be stored in its place (due to limitations of storage capacity). In some embodiments, memory 31 may record only upon certain criteria being met such as the receipt of an input from a sensor such as a motion detector. The input may indicate, for example, that motion has been detected within a trailer 15 or in the proximity of a trailer 15 or trailer hitch (not shown). In some embodiments, memory 31 may record upon the receipt of a particular input from a user interface (not shown) or other criteria such as the vehicle 25 being put into motion or being parked. Upon receipt of the input, at least one portable imager 12, 12A of image and display system 10 may begin to capture images and memory 31 may store image data from the captured images. The capture and storage of image data may continue until the occurrence of an event that causes the memory 31 to stop storing image data. The event may be, for example, the passage of a predetermined amount of time, the passage of a predetermined time during which no further inputs are received, the receipt of a user input, and the like.

In some embodiments, as shown in FIG. 3, first and second portable imagers 12, 12A may comprise a housing 16 including a center band 18 defining the top, bottom, and sides of the housing 16 in a continuous manner. A first cover 21 and a second cover 22 may be respectively assembled into the open first and second sides of the center band 18. The first cover 21 may include a lens aperture 24 therein for receiving a portion of a lens unit 26 such that the lens 28 included therein may be exposed externally of portable imager 12. In one implementation, a sealing member or compound may be positioned between lens aperture 24 and the adjacent portion of lens barrel 32 to facilitate any desired sealing of housing 16.

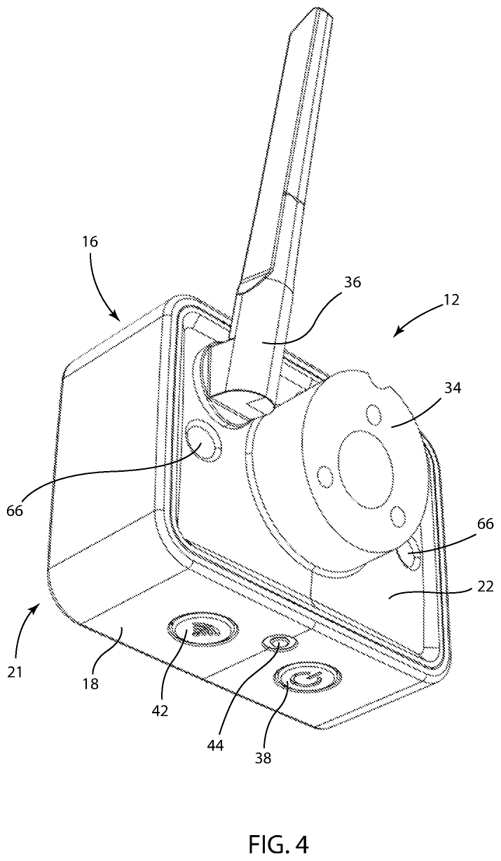

As shown in FIG. 4, in some embodiments, the above-mentioned mount 34 may be integrally formed with and may extend from second cover 22. Additionally, an antenna 36 may be configured to extend from housing 16. Antenna 36 may extend from one of second cover 22, first cover 21, and center band 18 of housing 16. In the example shown, antenna 36 may be a single unit fixedly mounted with second cover 22. In an alternative arrangement, antenna 36 may be configured to rotate and/or articulate such that it may be adjustable for reasons relating to fit or optimal signal transmission.

As also shown in FIG. 4, in some embodiments, at least one external control may be positioned on housing for facilitating use of portable imager 12 with image and display system 10. As shown, a power button 38, a pair button 42, and a reset button 44 may be positioned on the lower side of center band 18 although other control(s) may be used and still be within the scope of this disclosure. Describing the controls as shown, the power button 38 may be configured to toggle portable imager 12 between an on state and an off state. The pair button 42 may be used according to various particular protocols and processes to establish the wireless connection 13 between portable imager 12 and vehicle 25 (including with image processor 30, for example). The reset button 44 may be used to restore a default condition for portable imager 12 or to delete a stored connection so that portable imager 12 may be used with a different vehicle, for example.

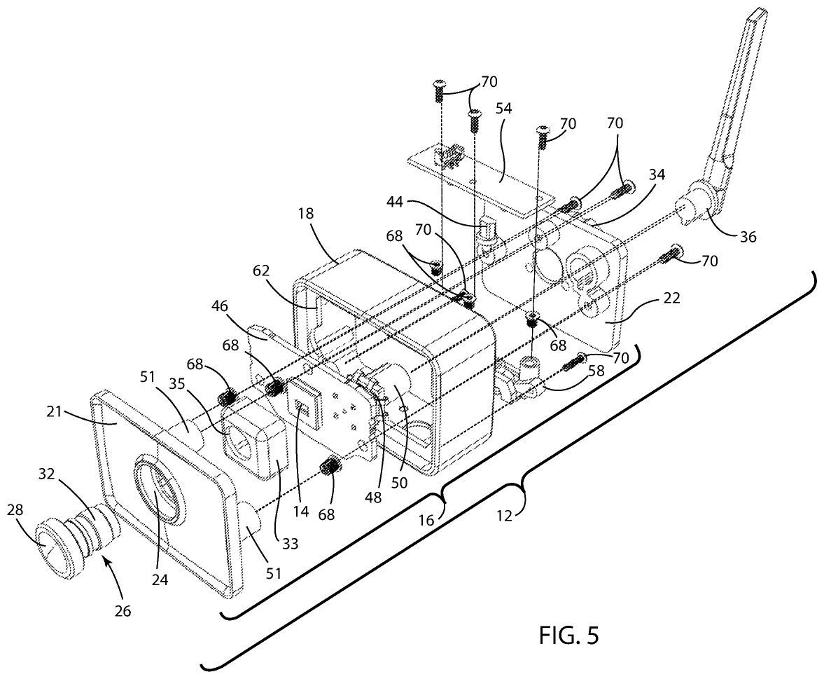

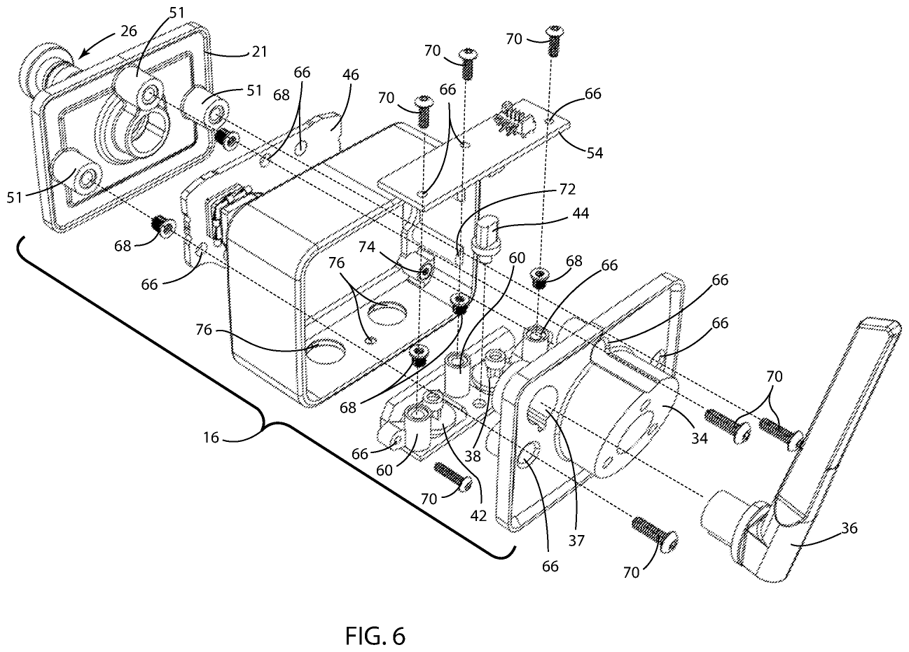

Turning to FIGS. 5 and 6, the construction of portable imagers 12, 12A, including internal components thereof, is discussed in greater detail. In particular, as shown in FIG. 5, printed circuit board (PCB) 46 with image sensor 14 mounted thereto may be received within housing 16 and positioned adjacent first cover 21 such that lens 26 may be positioned relative to image sensor 14 to focus the image within first field of view A onto image sensor 14.

PCB 46 may also include a wireless communication chip or module 48 thereon with a connector 50 extending therefrom to couple with antenna 36. This may allow portable imager 12, 12A to be configured for wireless communication with image and display system 10, including by one or more wireless communication protocols suitable for streaming video.

As discussed above, lens barrel 32 may retain lens 28 therein to form lens unit 26. In some embodiments, lens barrel 32 may retain additional lenses (not shown) configured to assist lens 28 to focus first field of view A onto image sensor 14. Lens barrel 32 may extend through and be externally exposed within the aperture 24 in first cover 21. Lens barrel 32 may be sealed therein by a deposited material or separate sealing member. A lens holder 33 having an aperture 35 may couple PCB 46 with lens unit 26. Lens holder 33 may be configured to position lens unit 26 and lens 28 to be aligned with image sensor 14 by affixing lens barrel 32 within aperture 35 of lens holder 33.

Lens barrel 32 may be affixed within aperture 35 using various adhesives, cements, or the like or may be press-fit within aperture 35. Lens holder 33 may be secured to PCB 46, and may be disposed adjacent to or surrounding image sensor 14. The securing of lens holder 33 to PCB 46 may be done by using adhesives, or one of lens holder 33 and PCB 46 may be adapted to be affixed using screws or other mechanical fasteners. In one aspect, the lens barrel 32 may be aligned with lens holder 33 for proper alignment of lens 28 with image sensor 14 and retained in position during curing of a cement or other adhesive requiring curing such that lens unit 26 may be affixed to PCB 46 and configured for proper alignment with image sensor 14 when portable imager 12 is assembled, as discussed further below.

Continuing with respect to FIG. 5, the PCB 46 may be affixed to and supported by first cover 21. In some embodiments, first cover 21 may include, on an interior side thereof, a plurality of supports 51 configured to space PCB 46 at a distance relative to lens 28 for proper focusing of the image on image sensor 14. In the illustrated example, first cover 21 may include three supports 51 for planar locating of PCB 46 relative to first cover 21 and lens barrel 32. Supports 51 may have respective inserts 68 assembled therewith (supports 51 being generally hollow or otherwise include holes therein for receiving inserts 68) by a press fit, which may be augmented by barbs extending on the exterior of inserts 68 and/or the use of adhesive or cement. Inserts 68 may be threaded such that they may receive respective screws 70 therein. Screws may be configured to operably engage with through holes 68 in PCB 46. First cover 21 may engage with center band 18 by fitting inside an open first side thereof and by abutting an interior flange 62 extending interiorly within center band 18. In various examples, a sealing gasket of rubber, neoprene, or the like, may be positioned between the outer periphery of first cover 21 and flange 62.

As further shown in FIG. 5, second cover 22 fits within center band 18 opposite first cover 21. Second cover 22 may include a plurality of projections 64 that extend from the interior side of second cover 22 and may be generally aligned with the supports 51 of first cover 21. Projections 64 may have through holes 66 therein that are open to the outside of second cover 22 with the through holes 66 in projections 64 aligning with the above-mentioned through holes 66 in PCB 46. In this manner, the assembly of portable imager 12, 12A may include positioning of PCB 46 within center band 18 and fitting of first cover 22 within center band 18 against flange 62. Second cover 22 may then be positioned within the open second side of center band 18 with screws 70 being assembled through the through holes 66 in second cover 22 and through the through holes 66 in PCB 46 and engaging with the threads in inserts 68, respectively. Such assembly may capture PCB 46 between the projections 64 and supports 60 under pressure of the engagement of screws 70 with inserts 68.

The resulting assembly may be secured with respect to center band 18 by the abutting of second cover 22 with a plurality of flanges 72 adjacent the open second side of center band 18 such that second cover 22 may be recessed into center band 18 in a manner similar to first cover 21. As with first cover 21, a sealing gasket or other member(s) may be positioned between flanges 72 and the adjacent portions of the interior surface of second cover 22. The addition of such an element may provide sealing of housing 16 and may allow fora compression fit of first and second covers 21, 22 with center band 18 with PCB 42 being received between projections 64 and supports 60 under a desired level of compression. After assembly of second cover 22, the antenna 36 may be assembled with connector 50 through an aperture 37 in one of center band 18, first cover 21, and second cover 22.

As shown in FIGS. 5 and 6, portable imager 12 may also include a control assembly within housing 16 that includes a button module 58 that includes at least one button 38, 42, 44 (which may be assembled or integral therewith), as well as supports 60 for control board 54. Control board 54 may connect and be in communication with PCB 46. Control board 54 may be configured for functionality related to the operation of portable imager 12 under the control of buttons 38, 42, 44. In some embodiments, the functionality may include powering portable imager 12 on and off, as well as establishing and terminating wireless connection 13 with image processor 30, although other functionalities may be included and still be within the scope of this disclosure.

Control board 54 may also couple with an internal power source (e.g. a rechargeable or replaceable battery, not shown) that may be received within housing 16 to power the operation of portable imager 12, including the operation of image sensor 14 and wireless module 48.

Control board 54 may be secured to supports 60 by additional screws 70 passing through holes 66 in control board 54 and engaging with inserts 68 received within hollow portions of supports 60. Supports 60 and buttons may be mutually sized and positioned such that buttons 38, 42, 44 may engage with corresponding switches on control board 54 for operation thereof. In some embodiments, reset button 44 may be formed on a separate body that may be received with button module 58 for operation of a corresponding switch on control board 54.

The assembled button module 58 and control board 54 may be assembled with housing by additional screws 70 that pass through holes 66 in button module 58 and engage with threaded holes 74 in center band 18 and are positioned such that buttons 38, 42, and 44 are aligned with corresponding apertures 76 in central band. In this manner, a separate membrane (not shown) may define an operable surface for buttons 38, 42, and 44 and may seal against the interior of center band 18 to further seal housing 16.

In assembly of portable imager 12, 12A, the control board 54 may be assembled with button module 58, which may then be assembled with center band 18 prior to the assembly of PCB 46 and first and second covers 21 and 22 with center band 18. Additionally, a battery may be connected with control board 54 and positioned within housing 16 before assembly of second cover 22 with center band 18 and securement of the assembly with the screws 70 that engage between second cover 22 and first cover 21. In an alternative arrangement, the functionality of control board 54 and PCB 46 may be incorporated into a single PCB with the switches arranged parallel to the PCB for actuation by the illustrated buttons in a variation of the illustrated button module lacking the supports of the illustrated embodiment and assembled separately with center band 18 from the single PCB.

With reference to FIG. 7, the image sensor 14 may include, for example, 2048 rows of pixels and between 1280 and 1600 columns of pixels. Note that more or fewer rows and/or columns of pixels may be used and still be within the scope of this disclosure. Depending upon the lenses used, in one example, this may represent a portion of first field of view A having, for example, a horizontal angle of 70 degrees and a vertical angle of 135 degrees which represents an aspect ratio of about 9:16.

Using first portable imager 12 as an example, the image processor 30 may be configured to create the back-up image 52 so that it corresponds to a portion B of the first field of view A cropped from a lower portion of the first field of view A. The portion B of the first field of view A may have the same horizontal angle H as the first field of view A. Thus, when looking at the image sensor 14 of the first portable imager 12 as shown in FIG. 4, the back-up image 52 corresponds to a subset of the pixels of the image sensor 14 that comprise the lower portion of the image sensor 14. For example, the back-up image 52 may be read from lowermost 1024 rows of pixels spanning all or nearly all the columns of pixels. Depending upon lenses used in the first portable imager 12, this may represent a portion B of the first field of view A having a horizontal angle and a vertical angle. The horizontal angle and the vertical angle may have an aspect ratio of about 1:1. For example, portion B of the first field of view A may have a horizontal angle of 70 degrees and a vertical angle of 67 degrees which represents an aspect ratio of about 1:1.

The rearward image 55 may be read from a subset of pixels in the top half of the image sensor across all or nearly all the columns of pixels. For example, the rearward image 55 may be read from about 30 rows in the top half of the image sensor across all or nearly all the columns of pixels. Depending upon lenses used in the first portable imager 12, this may represent a third portion C of first field of view A having a horizontal angle and a third vertical angle. For example, the portion C of first field of view A may have a horizontal angle of 70 degrees and a vertical angle of 15 degrees, which may represent an aspect ratio of at least about 4:1. Thus, the rearward image 55 corresponding to portion C of first field of view A may be cropped from a portion of the first field of view A above the lower portion, and the third portion C of first field of view A may have a horizontal angle and a vertical angle where the horizontal angle may be greater than the vertical angle.

The portable imagers 12, 12A may be in communication with the image processor 30 by wired or wireless connection 13 and 13A, respectively. The image processor 30 may select images from the second portable imager 12A when the vehicle 25 is not coupled to the trailer 15 and the vehicle 25 is backing up while within range for wireless communication with the second portable imager 12A. This may better allow a driver to back the vehicle 25 up to attach the trailer 15 to the trailer hitch or to determine how far the vehicle 25 can be backed up without hitting the trailer 15. When the vehicle 25 and the trailer 15 are coupled, the image processor 30 may select images from the first portable imager 12. When the vehicle 25 is not coupled to the trailer 15 and not within range for wireless communication with the portable imagers 12, 12A, image processor 30 may process images from vehicle imager(s) 20 for display on the display 40.

Display 40 may be in communication with image processor 30 and may be capable of selectively displaying at least one of the first image, second image, first supplementary image, second supplementary image, first additional image, and second additional image. Display 40 may also be capable of displaying images from vehicle imagers 20. Display 40 may be configurable to display images from at least one of first portable imager 12, second portable imager 12A, and both first and second portable imagers 12, 12A.

The display 40 may be configured for mounting within a rearview assembly mounted to one of a roof and a windshield of the vehicle 25. Thus, the display 40 may serve as a replacement or supplement to an internal rearview mirror. Additionally, or alternatively, the display 40 may be provided elsewhere in the vehicle 25 such as in a center stack of an instrument panel.

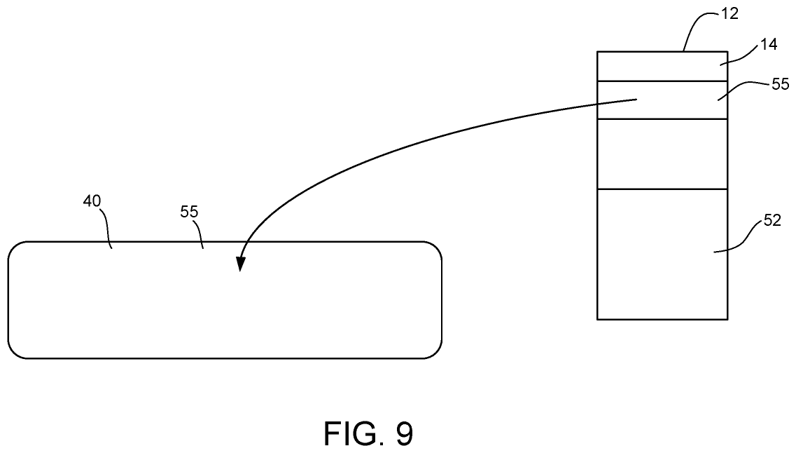

The image processor 30 may be configured to receive an input indicating whether the vehicle 25 is in a reverse gear. When the vehicle 25 is not in reverse, the image processor 30 may only read the rearward image 55 from the image sensor 14 of the first portable imager 12 and format the rearward image for display across the entire display 40 as shown in FIG. 9. However, when the vehicle 25 is in reverse, the image processor 30 may be configured to read both the rearward image 55 and the back-up image 52 from the image sensor 14. Image processor 30 may format the two images in a side-by-side, or a picture-in-picture format for simultaneous display on the display 40 as shown in FIG. 8. This may allow the driver to simultaneously view the back-up image 52 from the second portion B of first field of view A near the bumper of the trailer 15 and the rearward image 55 from the third portion C of first field of view A above the second portion B. If only the back-up image 52 were shown, the view would not show objects at any distance, whereas if only the rearward image 55 were shown, the driver would not be able to see objects close to the back of the trailer 15. Providing both images allows a driver to see both objects close to the back of the trailer 15 and objects at a distance.

It may also be possible to configure the image processor 30 to receive an input from a user input that allows a driver to select which images to display on display 40. Although a reverse gear input may be described as one input to the image processor 30, various other signals could be used to trigger a change in what is displayed on display 40. For example, inputs may be received from an ultrasonic backup signal, a user button, or a vehicle speed. For example, when the vehicle 25 is traveling at a low speed, the back-up image 52 and the rearward image 55 may be simultaneously displayed.

Although the above description pertains to portable imagers 12, 12A, one or more vehicle cameras or imagers 20 may be mounted such that they capture first images from a field of view having a horizontal angle and a vertical angle where the vertical angle may be greater than the horizontal angle and where the field of view has an aspect ratio of about 9:16. The image processor 30 may likewise crop the first images received from the vehicle imager 20 into a first supplementary image and a second supplementary image. The first supplementary image may comprise a back-up image. The back-up image may be of a lower field of view encompassing either a hitch mounted to the vehicle 25 or a bed of the vehicle 25. The second supplementary image may be of a higher field of view such as rearward of the vehicle 25, for example. Based on an input received by the image processor 30, the image processor 30 may select either one or both of the first supplementary and the second supplementary images for display on the display 40. The input may be, for example, related to a vehicle gear, vehicle speed, user input, ultrasonic back-up signal, and the like.

Image and display system 10 may also provide additional trailer views such as a view of the tow vehicle 25 from behind, an interior trailer view and a surround view. Image and display system 10 may be configured to record the images from portable imager(s) 12, 12A if sensors in communication with image and display system 10 indicate there is movement in the trailer or movement in proximity to the exterior of the trailer when the vehicle 25 is stopped or parked. Image and display system may be configured to cause a notification to be transmitted to a user. The notification may be transmitted via WIFI or LTE. The user may then be able to view or download captured images and/or video.

Portable imager 12 and/or 12A (or an additional imager) may be provided inside and/or outside of trailer 15 to capture images inside the trailer or outside the trailer. If provided inside the trailer, cargo (e.g., livestock) may be monitored. Further, the trailer imager(s) may be used as security imager(s) for monitoring the area around and inside the trailer 15.

The user interface may be capable of, upon receipt of a user input, saving images captured within a predetermined time interval prior to the receipt of the user input. In some embodiments, video images captured by portable imager(s) 12, 12A may be streamed and/or recorded for real-time or subsequent viewing on display 40 or on a user's mobile phone or other device. In some embodiments, video captured by portable imager(s) 12, 12A may be stored in memory 31 for a period of time.

In some embodiments, image and display system 10 may be configured to automatically, upon receipt of a particular user input, save images captured for a predetermined amount of time prior to the receipt of the input. Image and display system may further be configured to save images for a period after the receipt of the particular user input.

The rearview mirror assembly further may comprise a user interface capable of, upon receipt of a user input, causing the saving of images captured within a predetermined time interval prior to the receipt of the user input.

Image and display system 10 may be configured to store image data from captured images in memory 31. Memory 31 may be local to image and display system 10. In some embodiments, image and display system 10 may be in communication with and configured to store image data in a media storage card. Alternatively, or additionally, image and display system 10 may store image data from captured images in a remote memory 39, such as a remote server or cloud storage. User may be capable of accessing images stored in memory 31, 39 and causing images to be displayed on display 40. In some embodiments, image and display system 10 may be capable of causing images from image data stored in memory 31, 39 to be displayed on a mobile communications device such as a smart phone or a tablet computer.

Memory 31, 39 may comprise a certain storage capacity for storing images. Once the storage capacity has been reached, new images may be written over previously-stored images, thereby erasing the previously-stored images. Image and display system may be configured to write over the oldest stored images first.

In some embodiments, a user may indicate through user interface that the user desires images be saved. For example, image and display system 10 may receive, through user interface, an input indicating that images should be saved. Upon receipt of the indication, image processor 30 may place images captured within a predetermined period of time, such as the ninety seconds prior to the receipt of the input, into a saved status.

Images may be placed in a saved status and may remain in the saved status until the receipt of a user input indicating that the particular saved images no longer need to be in a saved status and may be over-written with new images. If images are in a saved status, those images may not be written over until the occurrence of a predetermined event. This may be done by a user via a user interface or other means, after the images in the saved status have been viewed, by the passage of a predetermined amount of time, or according to another criteria. The predetermined event may be the passage of a set period of time, the receipt of a particular user input, and the like.

Image and display system 10 may be configured to be activated upon the vehicle 25 being turned on or the ignition of the vehicle 25 being started. In some embodiments, once image and display system 10 has been activated, first portable imager 12 may begin capturing images. In some embodiments, first portable imager 12 may begin capturing images once a particular event has occurred. The particular event may be, for example, putting the vehicle 25 into a forward or reverse gear or interacting with a user interface (not shown) of image and display system 10. Second portable imager 12A may be activated simultaneously with first portable imager 12 or separately.

Power may be supplied to image and display system 10 by a power supply (not shown). Power supply may be associated with the vehicle 25 or may be associated with image and display system 10. In some embodiments, image and display system 10 may be configured to turn off after the vehicle ignition and/or power to the vehicle accessories is turned off. In some embodiments, image and display system 10 may continue to operate until the occurrence of a particular event or for a predetermined period of time after the vehicle ignition and/or power to vehicle accessories is turned off.

The above description is considered that of the preferred embodiments only. Modifications of the disclosure will occur to those skilled in the art and to those who make or use the disclosure. Therefore, it may be understood that the embodiments shown in the drawings and described above are merely for illustrative purposes and not intended to limit the scope of the disclosure, which is defined by the following claims as interpreted according to the principles of patent law, including the doctrine of equivalents. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

In this document, relational terms, such as first and second, top and bottom, front and back, left and right, vertical, horizontal, and the like, are used solely to distinguish one entity or action from another entity or action, without necessarily requiring or implying any actual such relationship, order, or number of such entities or actions. These terms are not meant to limit the element which they describe, as the various elements may be oriented differently in various applications. Furthermore, it is to be understood that the device may assume various orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

It will be understood that any described processes or steps within described processes may be combined with other disclosed processes or steps to form structures within the scope of the present disclosure. The exemplary processes disclosed herein are for illustrative purposes and are not to be construed as limiting. It is also to be understood that variations and modifications may be made on the aforementioned methods without departing from the concepts of the present disclosure, and further it is to be understood that such concepts are intended to be covered by the following claims unless these claims by their language expressly state otherwise.

As used herein, the term “and/or,” when used in a list of two or more items, means that any one of the listed items may be employed by itself, or any combination of two or more of the listed items may be employed. For example, if a composition is described as containing components A, B, and/or C, the composition may contain A alone; B alone; C alone; A and B in combination; A and C in combination; B and C in combination; or A, B, and C in combination.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within at least one of 2% of each other, 5% of each other, and 10% of each other.

What is claimed is:

1. An imaging and display system for use in a vehicle, the system comprising:
a first portable wireless vehicle imager mounted on a trailer such that the first portable wireless vehicle imager is oriented to capture images from a first field of view having a horizontal angle and a vertical angle greater than the horizontal angle;
an image processor for receiving and processing the image data from the images captured by the first portable wireless imager, the image processor configured to generate at least a first supplementary image from a first portion of the first field of view and a second supplementary image from a second portion of the first field of view; and
a display mounted in the vehicle and in communication with the image processor for displaying at least one of the first supplementary image and the second supplementary image.

2. The imaging and display system of claim 1, wherein the first supplementary image corresponds to a portion of the first field of view and is cropped from a lower portion of the first field of view, and the second supplementary image corresponds to a portion of the first field of view and is cropped from a portion of the first field of view above the lower portion.

3. The imaging and display system of claim 1, wherein the first portable wireless imager comprises:
a center housing band;
a first cover received in the center housing band within a first open side thereof and having a lens assembled therewith;
a second cover received in the center housing band within a second open side opposite the first open side; and
a printed circuit board having an image sensor mounted thereon, the printed circuit board being positioned within the center housing with the image processor aligned with the lens.

4. The imaging and display system of claim 1, further comprising a second portable wireless imager configured to have a second field of view different from the first field of view of the first portable wireless imager;
wherein the second portable wireless imager is in communication with the image processor; and
wherein the image processor is configured to generate at least a first additional image from a first portion of the second field of view and a second additional image from a second portion of the second field of view.

5. The imaging and display system of claim 1, wherein the first portable imager is disposed such that the lower portion of the first field of view includes a rear bumper of the trailer.

6. The imaging and display system of claim 1, wherein the first portable imager is configured to be selectively attachable to and removable from the trailer using a mount.

7. The imaging and display system of claim 1, wherein an image sensor is disposed on a printed circuit board within a housing, the printed circuit board further comprising a wireless communication module; and
wherein the wireless communication module is capable of allowing the image sensor to wirelessly communicate with the image processor and to stream video of captured images.

8. The imaging and display system of claim 7, further comprising an antenna extending from the housing, the antenna configured to allow the wireless communication module to be in selective communication with the image processor; and
wherein the first portable imager is provided with controls configured to allow the establishment of a wireless connection with the image processor.

9. The imaging and display system of claim 1, further comprising a memory in communication with the image processor and configured to selectively store images received or processed by image processor.

10. A portable wireless vehicle imager, comprising:
a housing comprising:
a center housing band;
a first cover received in the center housing band within a first open side thereof and having a lens assembled therewith; and
a second cover received in the center housing band within a second open side opposite the first open side; and
a printed circuit board having an image sensor mounted thereon, the printed circuit board being positioned within the center housing with the image processor aligned with the lens;
wherein the housing is fully enclosed and sealable to be water-proof.

11. The portable wireless vehicle imager of claim 10, further comprising a plurality of supports extending from the first cover within the center housing band and a plurality of projections extending from the second cover within the center housing band and toward respective ones of the plurality of supports; and
wherein the first cover and second cover abut a first interior feature and a second interior feature of the center housing band to retain the first cover and second cover with the center housing band.

12. The portable wireless vehicle imager of claim 10, further including a wireless communication module in communication with the printed circuit board and configured for transmitting an image gathered by the image sensor to a remote processor.

13. The portable wireless vehicle imager of claim 12, further including an antenna secured to the housing and communicatively connected with the wireless communication module.

14. The portable wireless vehicle imager of claim 10, wherein the first cover includes a lens aperture for receiving a portion of a lens unit including a lens such that the lens may be exposed externally of the portable wireless vehicle imager.

15. The portable wireless vehicle imager of claim 10, further comprising at least one external control positioned on the housing for facilitating use of portable imager.

16. An imaging and display system for a vehicle, comprising
a first portable wireless vehicle imager mounted on a trailer such that the first portable wireless vehicle imager is oriented to capture images from a first field of view having a horizontal angle and a vertical angle greater than the horizontal angle;
a second portable wireless vehicle imager mounted one of the vehicle and the trailer such that the second portable wireless vehicle imager is oriented to capture images from a second field of view having a horizontal angle and a vertical angle greater than the horizontal angle;
an image processor for receiving and processing image data from the images captured by the first and the second portable wireless imagers, the image processor configured to generate at least a first supplementary image from a first portion of the first field of view, a second supplementary image from a second portion of the first field of view, and a first additional image from a first portion of the second field of view; and
a display mounted in the vehicle and in communication with the image processor for displaying at least one of the first supplementary image, the second supplementary image, and the first additional image.

17. The imaging and display system of claim 16, wherein the image processor is further configured to generate a second additional image from a second portion of the second field of view; and
wherein the display is configured to selectively display the second additional image.

18. The imaging and display system of claim 16, wherein the first supplementary image corresponds to a portion of the first field of view and is cropped from a lower portion of the first field of view, the second supplementary image corresponds to the first field of view and is cropped from a portion of the first field of view above the lower portion, and the first additional image corresponds to a portion of the second field of view.

19. The imaging and display system of claim 16, wherein a first image sensor is disposed on a first printed circuit board within a first housing associated with the first portable wireless vehicle imager, the first printed circuit board further comprising a first wireless communication module;
wherein the first wireless communication module is capable of allowing the first image sensor to wirelessly communicate with the image processor and to stream video;
wherein a second image sensor is disposed on a second printed circuit board within a second housing associated with the second portable wireless vehicle imager, the second printed circuit board further comprising a second wireless communication module; and
wherein the second wireless communication module is capable of allowing the second image sensor to wirelessly communicate with the image processor and to stream video.

20. The imaging and display system of claim 16, wherein the first portable imager is provided with first controls configured to allow the establishment of a wireless connection with the image processor; and
wherein the second portable imager is provided with second controls configured to allow the establishment of a wireless connection with the image processor.
